(19) United States
(12) Patent Application Publication
(10) Pub. No.: US 2009/0063300 A1
(43) Pub. Date: Mar. 5, 2009

(54) METHOD AND APPARATUS FOR PROVIDING SHOE SELECTION SERVICES TO A PERSON

(75) Inventor: Andrew Feshbach, Santa Barbara, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: THE WALKING COMPANY

(21) Appl. No.: 11/848,201

(22) Filed: Aug. 30, 2007

(51) Int. Cl. G06Q 30/00

(52) U.S. Cl. 705/27

(57) ABSTRACT

Described herein is a method for providing shoe selection services to a person. The method includes providing a website for the sale of shoes and providing a list of categories, wherein the list of categories includes characteristics of shoes. The method further includes providing a list of options for each characteristic, providing a means for selecting an option from the list of options, and providing a means for evaluating the selected option and displaying shoes based upon the selected option.

### FIELD OF THE INVENTION

The present invention relates to a method and system for providing shoe selection services to a person.

### BACKGROUND OF THE INVENTION

People often have a difficult time selecting shoes that are appropriate for their needs. They often have to try on and purchase many pairs of shoes before they find a pair that meets their needs, as well as fits the physical parameters of their feet. This wastes time, energy, and money. Thus, a need exists for a method and system of providing shoe selection services to a person that addresses the foregoing problems.

### SUMMARY OF THE PREFERRED EMBODIMENTS

In accordance with one aspect of the present invention, there is provided a method for providing shoe selection services to a person. The method includes the steps of providing a website for the sale of shoes and providing a list of categories, wherein the list of categories includes different characteristics of shoes. The method further includes providing a list of options for each characteristic, providing a means for selecting an option from the list of options, and providing a means for evaluating the selected option and displaying shoes based upon the selected option.

In accordance with another aspect of the present invention, there is provided a method of providing shoe selection services to a person. The method includes the steps of identifying a plurality of selected shoes, and categorizing the plurality of identified shoes based upon one or more factors. The method further includes providing an internet website, providing on the website a list of one or more factors, providing the person with a means for selecting the one or more factors, identifying at least one shoe based upon the selected factor, and displaying the identified shoes on the website. The one or more factors comprises physical qualities of the shoe. Preferably, the one or more factors comprises physical qualities of a shoe wearer.

In accordance with another aspect of the invention, there is provided a method of providing comfort shoe selection services to a person. The method includes the steps of providing the person with a means for selecting at least one pair of shoes. The at least one pair of shoes is associated with at least one first factor. The person selects the shoe by selecting the at least one first factor. The at least one first factor includes at least one physical quality of the shoe. Preferably, the at least one first factor further comprises at least one second factor. The first factor can include women's comfort and men's comfort and/or foot condition. Each of women's comfort and men's comfort can further comprise at least one second factor chosen from the group comprising ultimate, everyday, and fashion. The method can include providing an internet website, wherein the website is operatively coupled to a database and configured to display the shoe information.

In accordance with another aspect of the present invention, there is provided a system for facilitating a shoe buyer's selection of appropriate shoes. The system includes a database of selected comfort shoes, a database of characteristics of the selected comfort shoes, a database of characteristics of users, and a database comprised of user selection of at least one characteristic chosen from characteristics of selected comfort shoes or characteristics of users. The system includes a software system for selecting at least one shoe based upon the user's selection of at least one characteristic chosen from characteristics of selected comfort shoes and characteristics of users. The system includes a means for displaying characteristics of selected comfort shoes, characteristics of users, and the shoe selection. Preferably, the characteristics of selected comfort shoes include comfort. Comfort can include ultimate, everyday, and fashion. Preferably, the characteristics of users include arch type, heel height, width, and foot condition. Preferably, the means for displaying the characteristics is an internet website.

### BRIEF DESCRIPTION OF THE DRAWINGS

The invention may be more readily understood by referring to the accompanying drawings in which:

FIG. 1 is block diagram of a system for facilitating a shoe buyer's selection of the appropriate shoes (as used herein also “shoe selection system” or “system for selecting shoes”) in accordance with a preferred embodiment of the present invention;

FIG. 2 is a block diagram of a computer system that may be used for implementing the system for facilitating a shoe buyer's selection of the appropriate shoes of FIG. 1, configured in accordance with a preferred embodiment of the present invention;

FIG. 3 is a network diagram illustrating a network of computer systems that may be used for implementing the shoe selection system of FIG. 1, configured in accordance with a preferred embodiment of the present invention;

FIG. 4 is a block diagram illustrating an exemplary method of shoe selection using the system of FIG. 1; and

FIG. 5 to FIG. 14 are a series of screenshots illustrating an example of the system for facilitating a shoe buyer's selection of the appropriate shoes of FIG. 1, configured in accordance with a preferred embodiment of the present invention.

### DETAILED DESCRIPTION OF THE PREFERRED EMBODIMENTS

According to the present invention, a method and system of providing shoe selection services to a person (also referred to herein as a method and system of “selecting shoes”, a method and system of “facilitating a shoe buyer's selection of the appropriate shoes”, a method and system of “providing comfort shoe selection services to a person”, or “comfort shoe selection services”) is provided. In a preferred embodiment, a shoe selection service provider provides shoe selection services to a user (also referred to herein as a “shoe selector”, “shoe buyer,” or a “person”) based upon the characteristics of the shoe and/or characteristics of the user wearing the shoe.

In a preferred embodiment, a shoe selection service provider selects shoes from a larger group of shoes based upon comfort, brand, type of shoe, function of the shoe, and/or other characteristics of the shoe and/or other characteristics of the users. The shoes selected from the larger group may be referred to herein as “selected comfort shoes,” “selected shoes,” “pair of shoes” or “comfort shoes.” Once the shoe selection service provider has selected shoes from the larger group, the shoe selection service provider further categorizes these shoes based upon one or more characteristics as described in detail later.

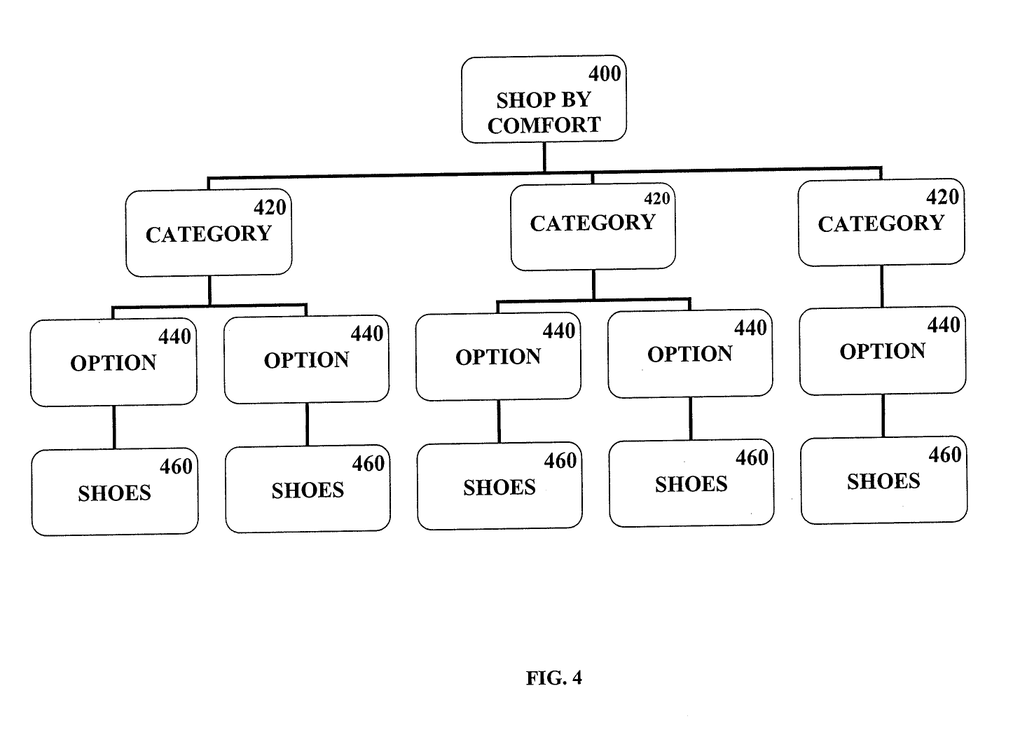

In a preferred embodiment, the method and system for providing shoe selection services to a user is facilitated by the use of an internet website. Preferably, the steps of the method can be described as follows: A user visits the home page of the website and logs onto the website. The website provides the user with a list, for example, “Shop Women's,” “Shop Men's,” “Shop by Comfort,” and “Shop by Brand” (herein referred to as “choices”). Referring to FIG. 4, the user selects the choice 400 (as used herein “select” is interchangeable with “hovering over” or clicking on) “Shop by Comfort.” Selecting this choice 400 provides the user with a list of categories 420. These categories 420 are based upon the characteristics of the shoes, characteristics of the user, or both the characteristics of the shoe and characteristics of the user. Preferably, each category 420 includes one or more options 440. The user selects the desired option 440, and one or more shoes 460 are identified based upon the selected option 440. The user subsequently selects one or more of the identified shoes 460 for purchase.

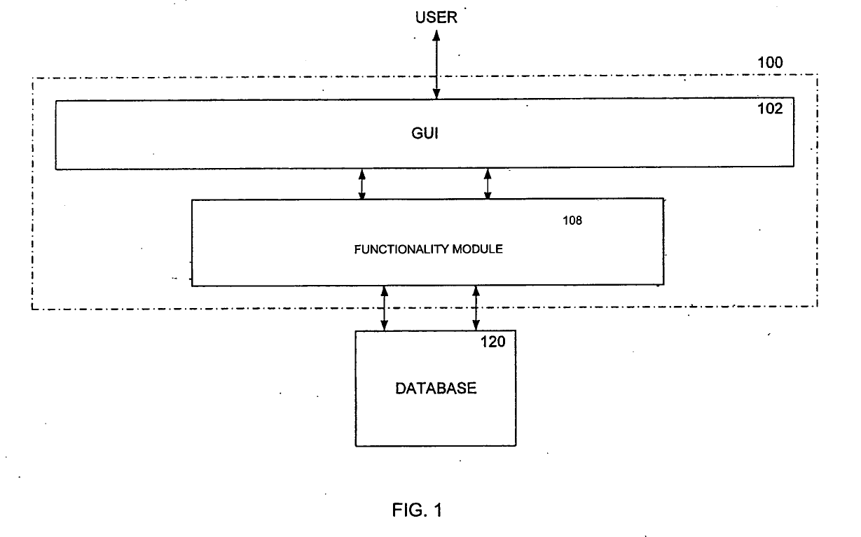

FIG. 1 is a block diagram of a system 100 for facilitating a shoe buyer's selection of the appropriate shoes in accordance with one preferred embodiment of the invention. The system 100 includes a graphical user interface (GUI) 102 coupled to a functionality module 108. The GUI 102 provides a user with access to the information stored in a database 120 using the functionality provided by the functionality module 108. As further described below, in one preferred embodiment, the database 120 stores information in one or more related databases that are logically grouped by predetermined areas. These areas may be, for example, shoe characteristic information, foot characteristic information, user selection information, information related to identified shoes, etc. As used herein, “database” should be understood to cover reference to a single database or a collection of databases. Thus, in one preferred embodiment, the database 120 includes a user selection information database, a shoe characteristic information database, and a user characteristic information database. In other embodiments, information may be stored or arranged using a variety of data storage software and hardware techniques known to those of ordinary skill in the art in database programming. For example, one database system that may be used with the present invention is the SQL Server system as offered by Microsoft Corp. Other data storage systems, such as those based on Oracle Database products offered by Oracle Corporation or the MySQL database server offered by MySQL AB, may be used. These data storage systems run on a variety of hardware platforms, including those based on the microprocessors offered by Advanced Micro Devices2, Inc., or Intel Corp. In addition, the system may include a software system for identifying shoes based upon user selection.

Referring to FIG. 1 and FIG. 4, the database 120 is preferably accessible by the functionality provided by the functionality module 108 in the shoe selection system 100. The user accesses the functionality module 108 through the GUI 102, as described herein, which is described through a series of exemplary screenshots of what a user would see on a preferred computer display. In a preferred embodiment, the functionality module 108 is a means for evaluating the user selection of an option 440. For example, the functionality module 108 may be a software system for identifying one or more shoes 460 based upon the user selection of the option 440. Subsequently, the identified shoe 460 may be displayed on the GUI 102.

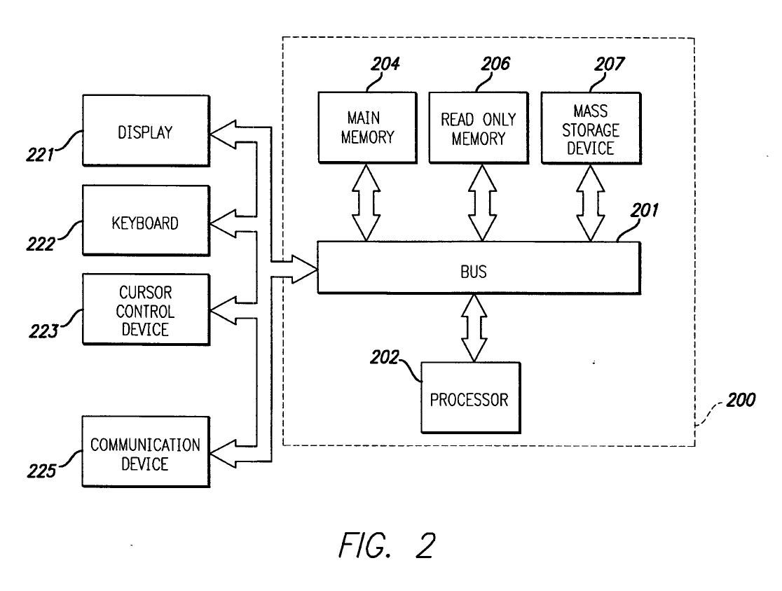

FIG. 2 illustrates an example of a computer system 200 in which the features of the present invention may be implemented. The computer system 200 includes a bus 201 for communicating information between the components in the computer system 200, and a processor 202 coupled with the bus 201 for executing software code, or instructions, and processing information. The computer system further comprises a main memory 204, which may be implemented using random access memory (RAM) and/or other random memory storage device, coupled to the bus 201 for storing information and instructions to be executed by the processor 202. The main memory 204 also may be used for storing temporary variables or other intermediate information during the execution of instructions by the processor 202. The computer system 200 also includes a read only memory (ROM) and/or other static storage device coupled to the bus 201 for storing static information and instructions for processor 202.

Another type of user input shown in the figure is a cursor control device 223, such as a conventional mouse, touch mouse, trackball, track pad, or other type of cursor direction keys for communicating direction information and command selection to the processor 202 and for controlling movement of a cursor on the display 221. Although not illustrated, the computer system 200 may optionally include video, camera, speakers, sound card, and many other conventional multimedia options. Various types of input devices, including, but not limited to the input devices described herein, unless otherwise noted, allow the user to provide command or input to the computer system 200. For example, in the various descriptions contained herein, reference may be made to the user “selecting,” “clicking,” or “inputting,” and any grammatical variations thereof, one or more items in a user interface. These should be understood to mean that the user is using one or more input devices to accomplish the input.

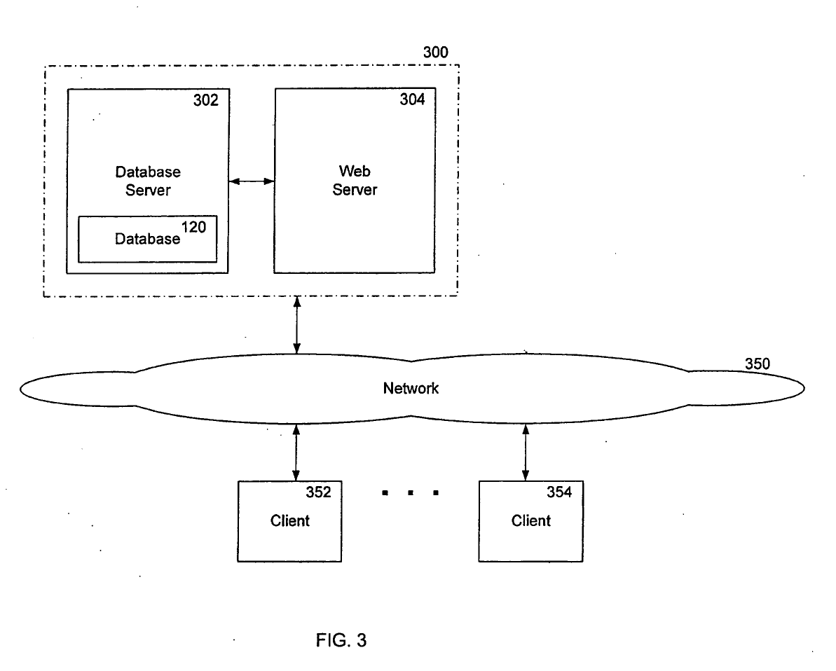

FIG. 3 illustrates a computer network including a server system 300 having a database server 302 for storing a database 120 and a web server 304 that stores the instructions necessary to access and present the information from, as well as store information into, the database 120. The user, using a client computer such as a client 352 and a client 354, accesses server system 300 through a network 350. Other systems, such as those belonging to a manufacturer may also be coupled to the server system 300. In the illustrated embodiment, the network 350 represents a variety of networks that may include one or more local area networks as well as wide area networks. The functionality provided by the database server 302, the web server 304, the client 352 and the client 354, as well as by the manufacturer may be implemented using a computer system having the characteristics of the computer system 200 described herein. It should be noted, however, that the specific implementation of the computer system or systems used to describe the present invention is not to be limiting unless otherwise specifically noted. For example, the functionality provided by the database server 302 and the web server 304 may be offered by one computer system. Further, the functionality provided by the database server 302 and 304 may be redistributed over several computers.

As described above, the user may interact with the information stored in the database 120 through the GUI 102. In the following description, the GUI 102 is implemented using one or more web pages (which may be referred to herein as “pages,” “screens,” or “forms”) provided by the web server 304 accessible by the user using any Internet web browser software, such as the Internet Explorer browser provided by Microsoft Corp., on a client computer such as the client 352. In another embodiment, one or more custom software programs can be created to implement the system described herein. Of course, the web server 304 may itself have browser software installed on it so as to be accessed by the user. Further, throughout the description of the various embodiments of the invention herein, references are made to the user performing such actions as selecting buttons or clicking on, executing searches or updates on the database 120. In one preferred embodiment, these requests are generated by the user interacting with the browser. Preferably, the one or more web pages described herein may include a form interface (e.g., a drop down menu, a radio button selection, etc.). Once the user has provided such selection, the user may select a button or a link on the web page to request an update of the database 120 with the information. The browser will send the web server 304 a link that includes the information (i.e., the user's selection) being sent as well as the request to update the database 120.

FIG. 4 is a block diagram illustrating an exemplary method of shoe selection of the present invention. The user first selects the choice 400 Shop By Comfort. Preferably, selecting this choice 400 provides the user with one or more categories 420 (as used herein, categories may also be referred to as “first factors”). Selecting a category 420 provides the user with one or more options 440 (as used herein, options may also be referred to as “second factors”). Selecting an option 440 may provide the user with (1) more options or (2) identified shoes 460. The categories 420 and options 440 may refer to characteristics of the shoe and/or characteristics of the user wearing the shoe. In a preferred embodiment, choices 400 comprise Shop Women's, Shop Men's, Shop By Brand, Sweepstakes, Shopping Bag, and Sign In. Preferably, categories 420 comprise Women's Comfort, Men's Comfort, Arch Type, Heel Height, Foot Type, and Foot Condition. Preferably, the options 440 under each of Women's Comfort and Men's Comfort comprises Ultimate, Everyday, and Fashion; the options 440 under Arch Type comprise High, Medium, and Low; the options 440 under Heel Height comprise High, Medium, and Low; the options 440 under Foot Type comprise Wide, Medium, and Narrow; and the options 440 under Foot Condition comprise Heel Spurs, Plantar Fasciitis, and Bunions. However, the present invention may comprise more or less choices 400, categories 420, options 440, and identified shoes 460, without departing from the scope of the present invention.

As shown in FIG. 4 and described above, reference will be made to choices 400, categories 420, options 440, or identified shoes 460, as other figures are discussed below.

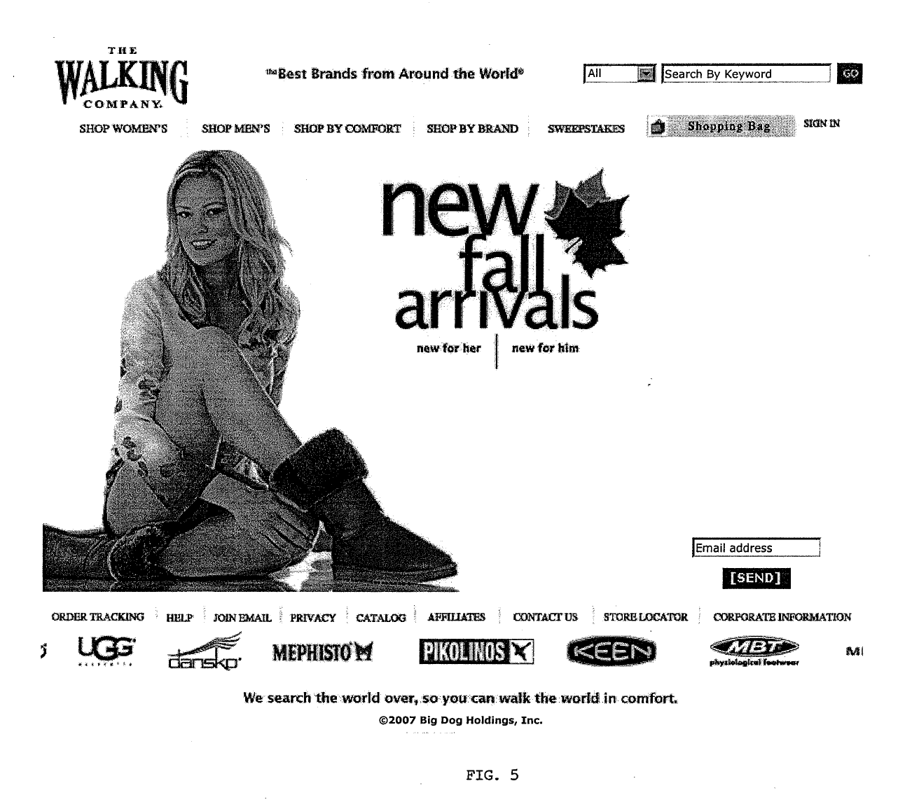

FIGS. 5-14 show screens from a website of the shoe selection system 100, implementing the method and system of providing shoe selection services to a person. Techniques for programming computers to generate such screens are known. Any number of screen designs, layouts, and sequences may be used without departing from the scope of the present invention.

FIG. 5 illustrates an exemplary screenshot of a primary homepage of the system of selecting shoes 100. On the top of the web page lists the following choices 400: Shop Women's, Shop Men's, Shop By Comfort, Shop by Brand, Sweepstakes, Shopping Bag, and Sign In. At this point, the user may log onto the website by selecting SIGN IN on the upper right of the web page. Alternatively, the user may begin selecting shoes and log onto the website later, preferably at check out. However, the present invention does not require the user to log onto the website. The user may identify shoes of interest without logging onto the website.

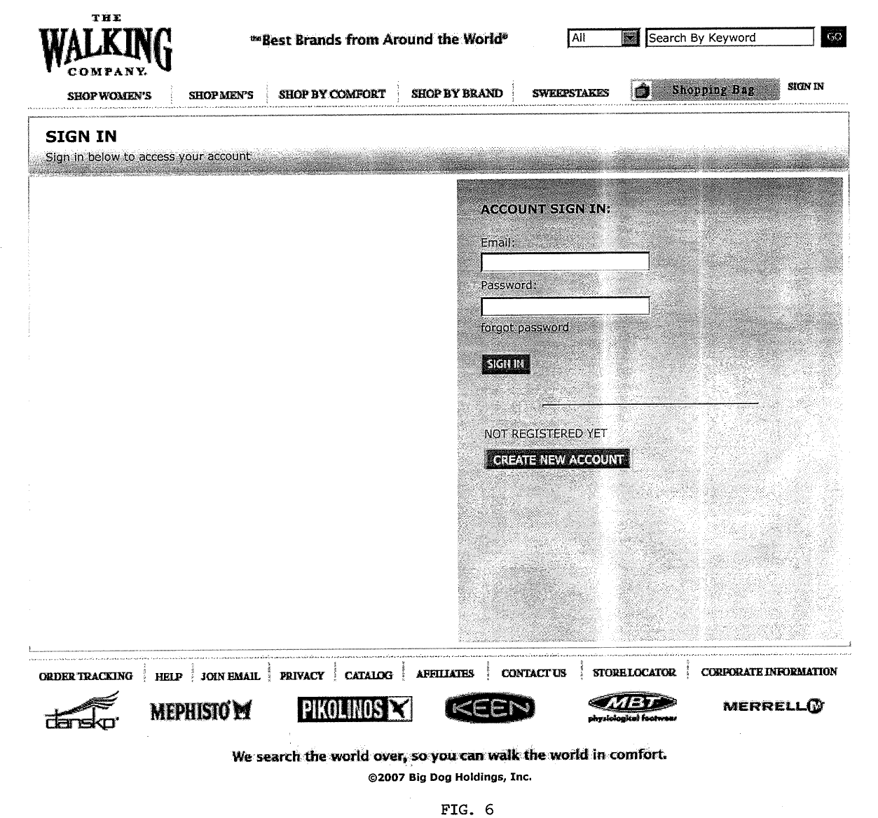

If the user decides to log onto the website at this point, the user selects SIGN IN on the right side of the homepage of FIG. 5. In a preferred embodiment, selection of SIGN IN directs the user to the webpage shown in FIG. 6. The user may either create a new account or sign in using user name and/or password, if an account has already been created. Logging onto the website allows the user to view current and pending orders and/or the shopping bag, etc.

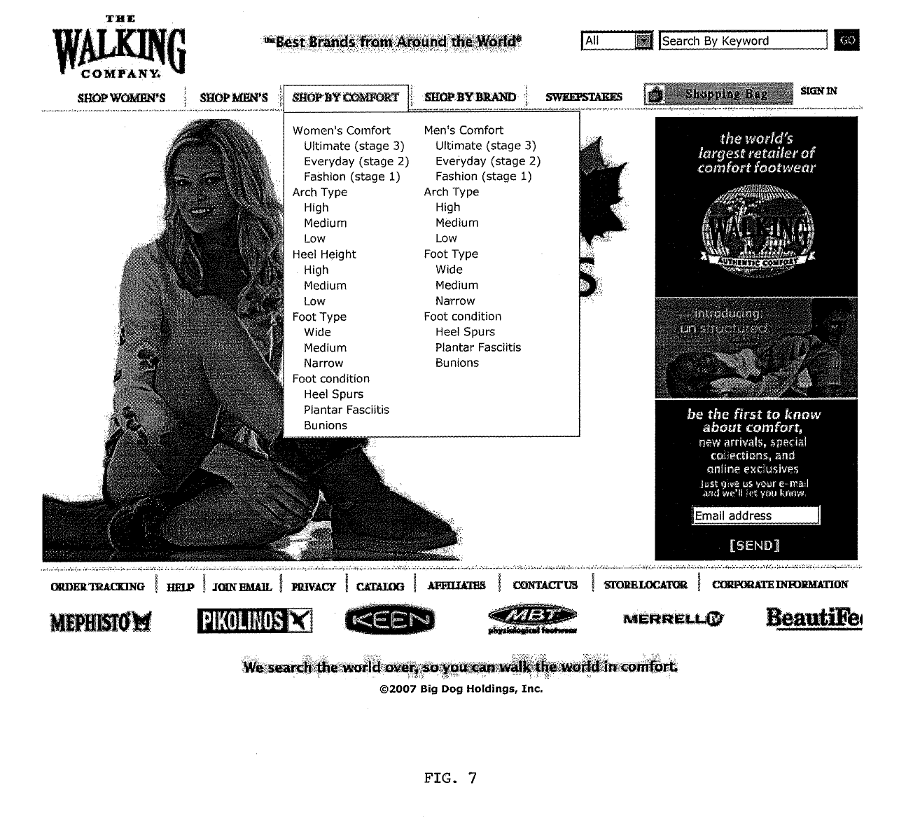

If the user decides to begin selecting shoes, the user may select the choice Shop By Comfort as shown in FIG. 5 by “hovering over” the words Shop By Comfort. Referring to FIGS. 4 and 7, by hovering over this choice, a list of categories 420, as well as a list of options 440 within those categories 420, are displayed. The list of categories 420 preferably includes characteristics of shoes and/or characteristics of users. In a preferred embodiment, there are two separate columns: one for women's shoes and the other for men's shoes. Within each column, there is provided a list of categories 420. Preferably, one column includes or comprises of women's shoes that are placed in the following categories 420: Women's Comfort, Arch Type, Heel Height, Foot Type, and Foot Condition. Preferably, the other column includes or comprises of men's shoes that are placed in the following categories 420: Men's Comfort, Arch Type, Foot Type, and Foot Condition. Generally, the user does not select the category name itself; the user selects an option 440 under the category 440. Selecting an option 440 preferably leads to another web page displaying a plurality of shoes 460, as will be described in detail later.

However, rather than “hovering over” the Shop By Comfort choice 400, the user may select the choice by clicking on it, leading to another web page that provides the list of categories 420 described above. It is understood that the list of categories 420 may be accessed without requiring the user to select a choice 400, or may require the user to select more choices or different choices before accessing the list of categories 420. In addition, the order of selection of categories 420 and/or of options 440 that lead to the identified shoes 460 may be different. For example, instead of being listed in a gender-specific fashion, the shoes may be initially divided by one or more characteristics of the shoe and/or one or more characteristics of the shoe wearer. Subsequently, the shoes may be divided into a gender-specific fashion within those characteristics. For example, the shoes may be divided by comfort or type of shoe (i.e., sandal, etc.). Once the user selects one of these options 440, another screen may be provided wherein the user selects from men's shoes or women's shoes within the options 440. The shoes identified 460 may be displayed on the same web page or may be displayed on a different web page. In addition, the present invention is not limited to the categories 420 and/or options 440 shown in FIG. 6. More or less categories 420 and/or more or less options 440 may be provided without departing from the scope of the present invention. For example, kid's shoes, athletic shoes, etc. may be added as categories 420 or options 440. Additional categories 420 and/or options 440 may be added such as Casual Comfort, Performance Comfort, Sporty Comfort, Dress Comfort, Active Comfort, Walking Comfort, Business Casual Comfort, and/or Active Casual Comfort, or the like.

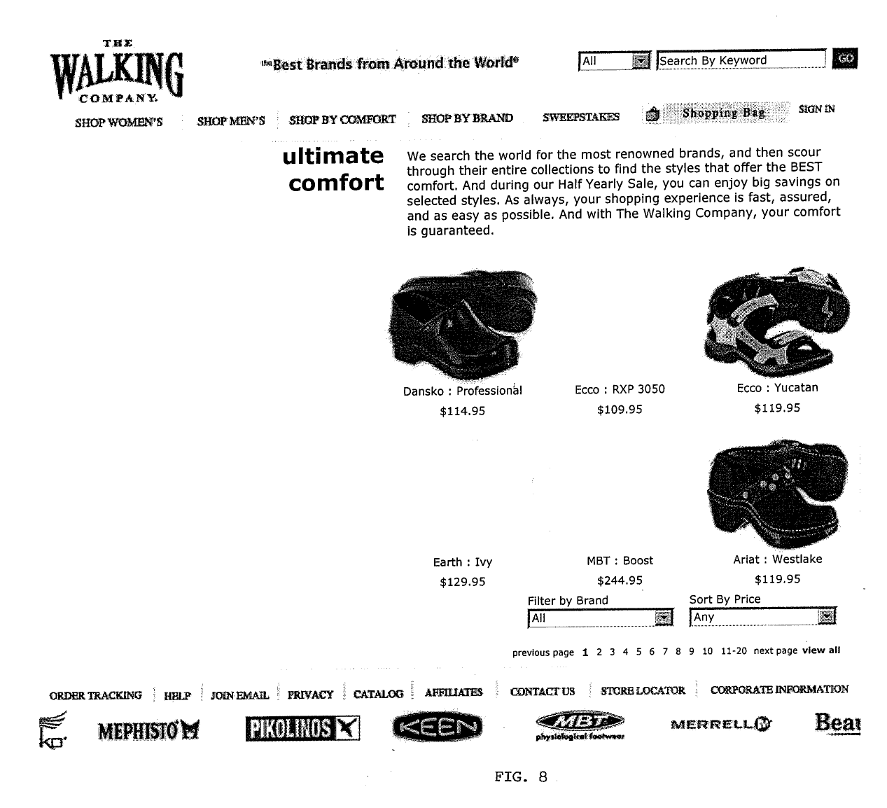

FIGS. 8-14 below are exemplary screen shots of web pages displayed after the user selects an option under the category Women's Comfort. However, it is to be understood that any other option 440 under any other category 420 would provide screen shots having similar layouts as those shown in FIGS. 8-14.

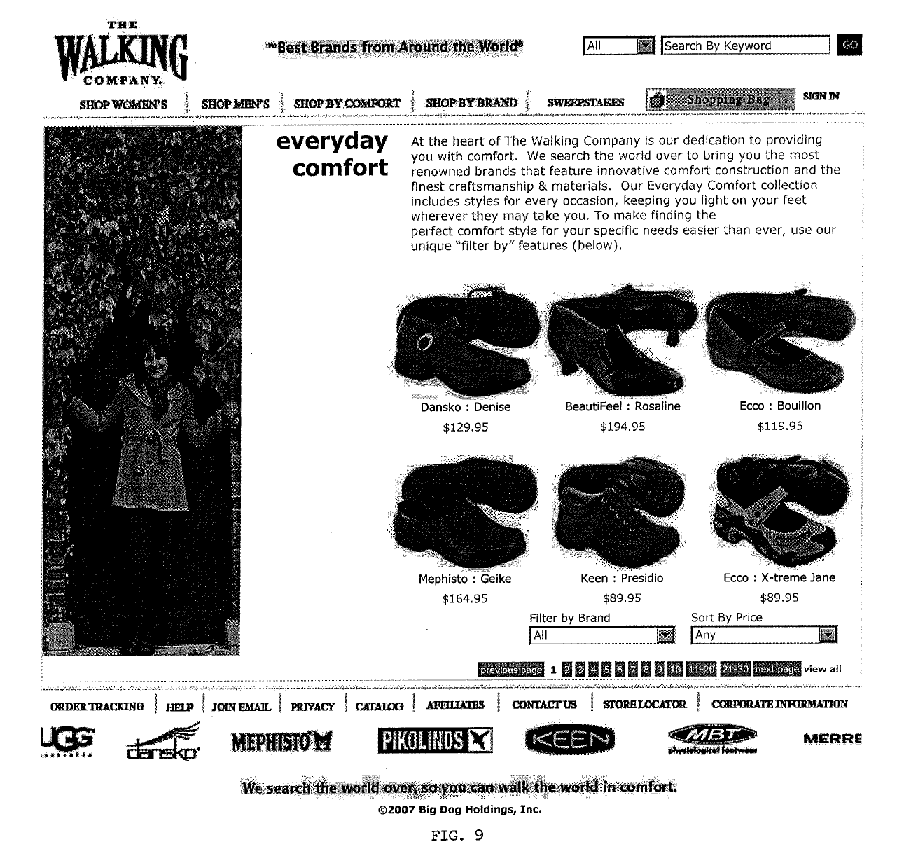

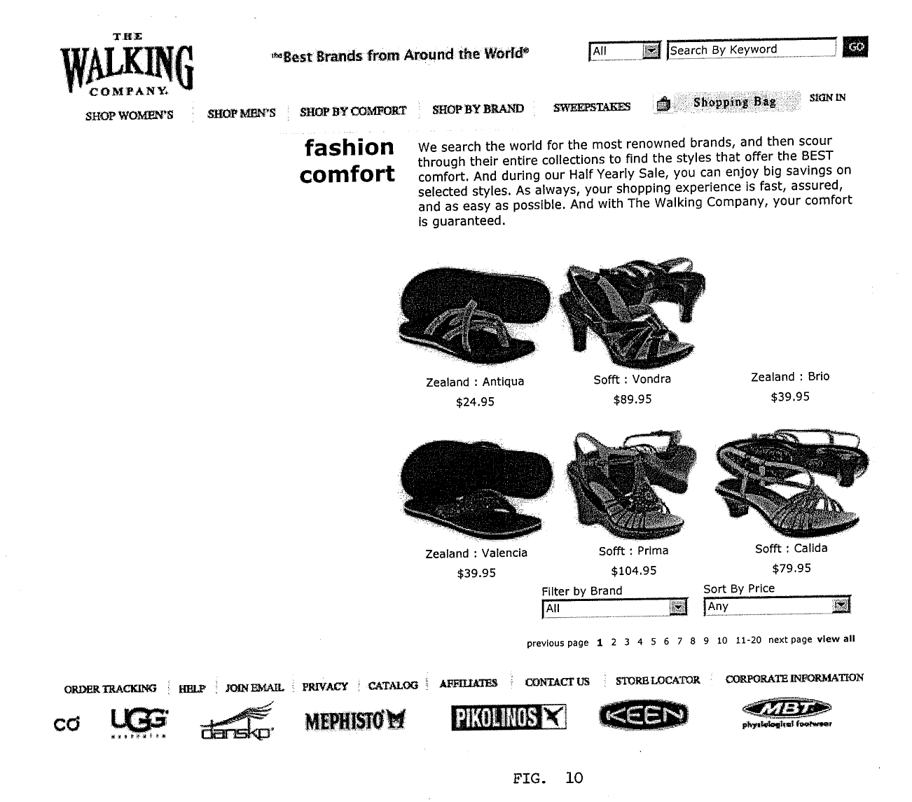

FIG. 8 is an exemplary screen shot of the web page displayed after the user selects the option Ultimate Comfort under the Women's Comfort category. Likewise, FIGS. 9 and 10 are exemplary screen shots of web pages displayed after the user selects Everyday and Fashion, respectively, from the category Women's Comfort. Preferably, a plurality of women's shoes identified to be of “Ultimate,” “Everyday,” or “Fashion” comfort level are displayed. Generally, more shoes are identified than can fit on a web page. Preferably, at the bottom of each of the web pages there are page numbers wherein the user may select a page number to see other shoes identified to be of Ultimate, Everyday, or Fashion comfort level. It is to be understood that one or more shoes may be identified to fit within the parameters of more than one option 440. As such, one or more of the shoes displayed on this web page may also be identified and displayed when other options 440 are selected. For example, selecting “Ultimate” for comfort and “low” for Arch Type may identify and display the same shoe or shoes.

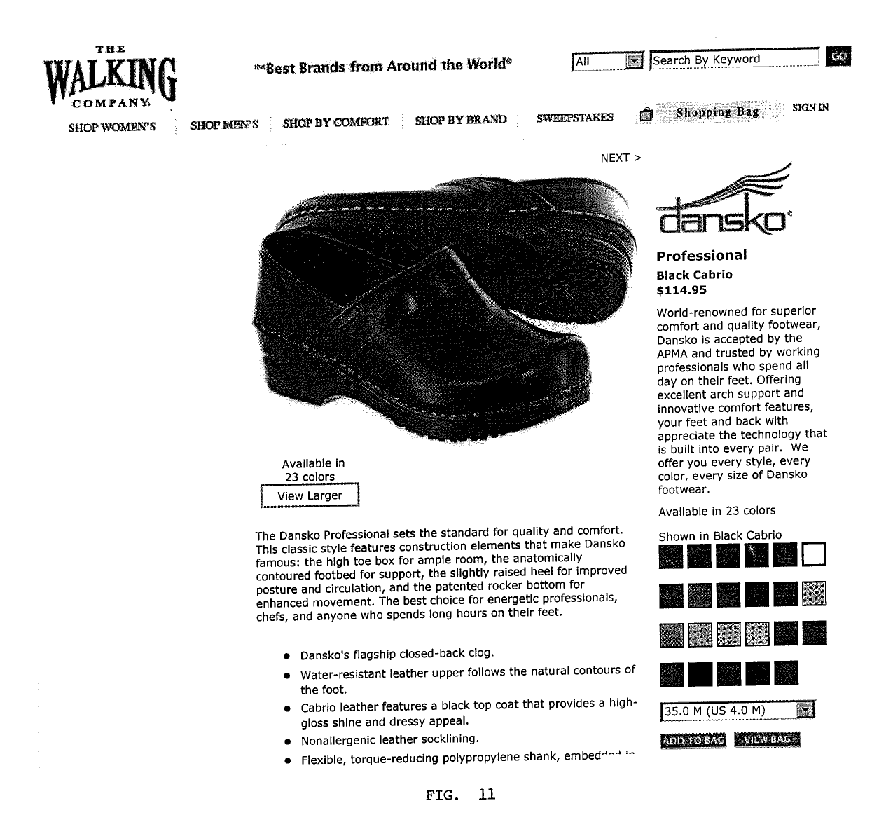

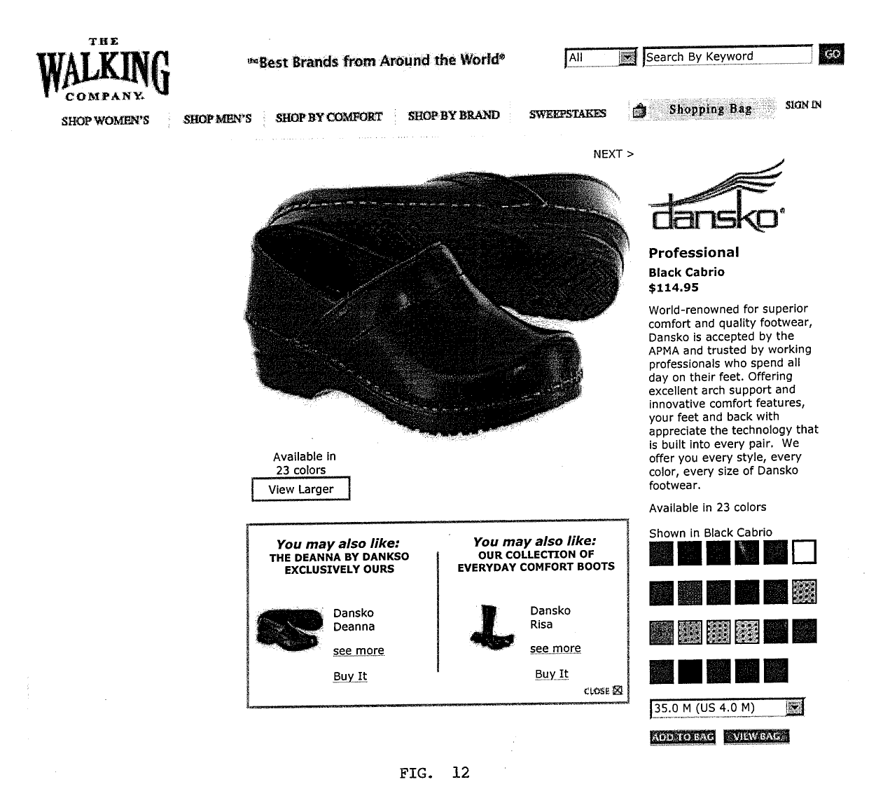

FIG. 11 is a screen shot of the web page displayed after the user selects a shoe from the plurality of shoes identified in FIG. 8 as of Ultimate comfort level. At this point, the user may select “Add to Bag” displayed on the right side of the screen shot of the web page. After selecting “Add to Bag,” if the user has already logged onto the website, the user will be directed to the screen shot of the web page as shown, for example, in FIG. 12. If the user has not logged onto the website, the user may be directed to the web page as shown, for example, in FIG. 6.

In a preferred embodiment, FIG. 12 is a screen shot of a web page displayed after the user selects “Add to Bag” as described above. Upon selecting “Add to Bag,” a pop up box displaying one or more additional shoes that are similar to the user's selected shoe shown in FIG. 11 is displayed on the screen. Preferably, the shoes in the pop up box are identified based upon the following: (1) the option 440 initially chosen by the user and (2) the shoe selected by the user based upon the option 440. As such, the shoes in the pop up box are based upon one or more characteristics chosen from characteristics of the shoe and/or characteristics of the user, as well as user selection of the identified shoes 460. In this way, once a user selects a desired shoe from the plurality of shoes 460 identified, the pop up box may give the user further shoe selection information by identifying and displaying shoes similar to the selected shoes. For example, once the user selects a particular shoe (for example, a sandal) from the plurality of shoes, additional shoes (for example, additional sandals at the same or similar comfort level), may be identified from the plurality of shoes. In this way, smaller subsets of shoes are identified from the larger group based upon the user's initial selection of a shoe. However, the invention is not limited to one pop up box. For example, once the user selects a shoe from the pop up box, additional shoes similar to the shoe selected from the first pop up box may be displayed in a second pop up box. In this way, an even smaller subset of shoes may be identified based upon the initial option selected by the user. Instead of pop up boxes, links, drop down boxes, etc. may be provided to further limit the shoe selection.

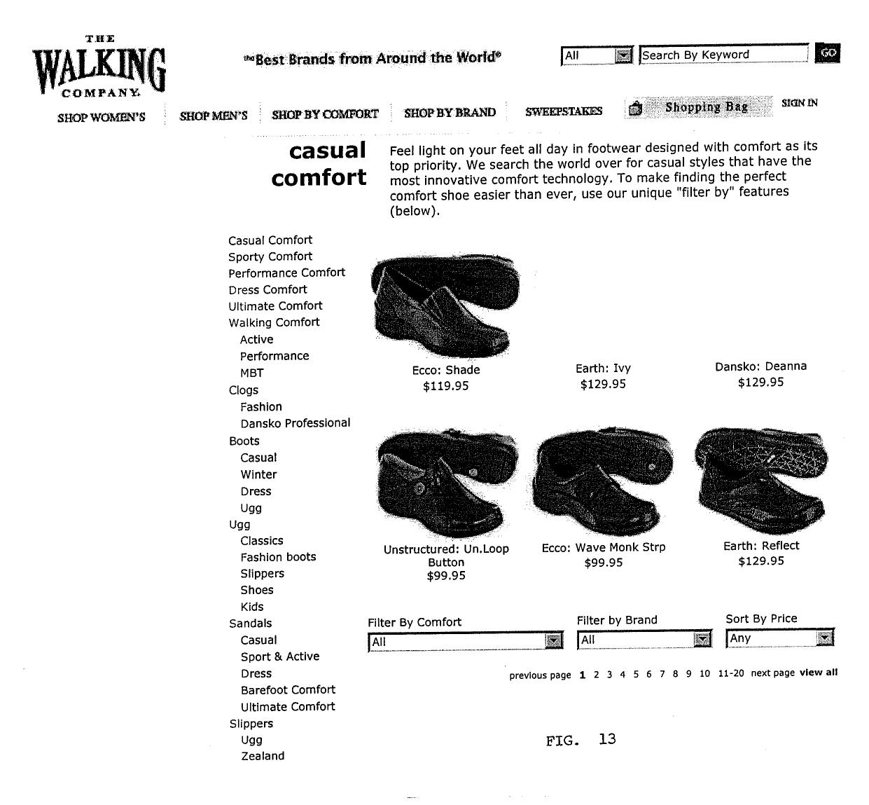

FIG. 13 is a screen shot showing the screen displayed after the user selects “see more” in the pop up box having the Dansko Deanna shoe (which is only exemplary) shown in FIG. 12. A plurality of shoes are displayed preferably having one or more similar characteristics to the shoe initially chosen by the user in FIG. 11. Preferably, the web page of FIG. 13 includes a drop down menu labeled FILTER BY COMFORT wherein the user may select amongst additional comfort levels. These comfort levels may be subsets of the option 440 already selected by the user in FIG. 7. The web page may also include a drop down box titled FILTER BY BRAND. However, instead of drop down boxes, any other type of form interface may be provided, such as a radio button selection, etc.).

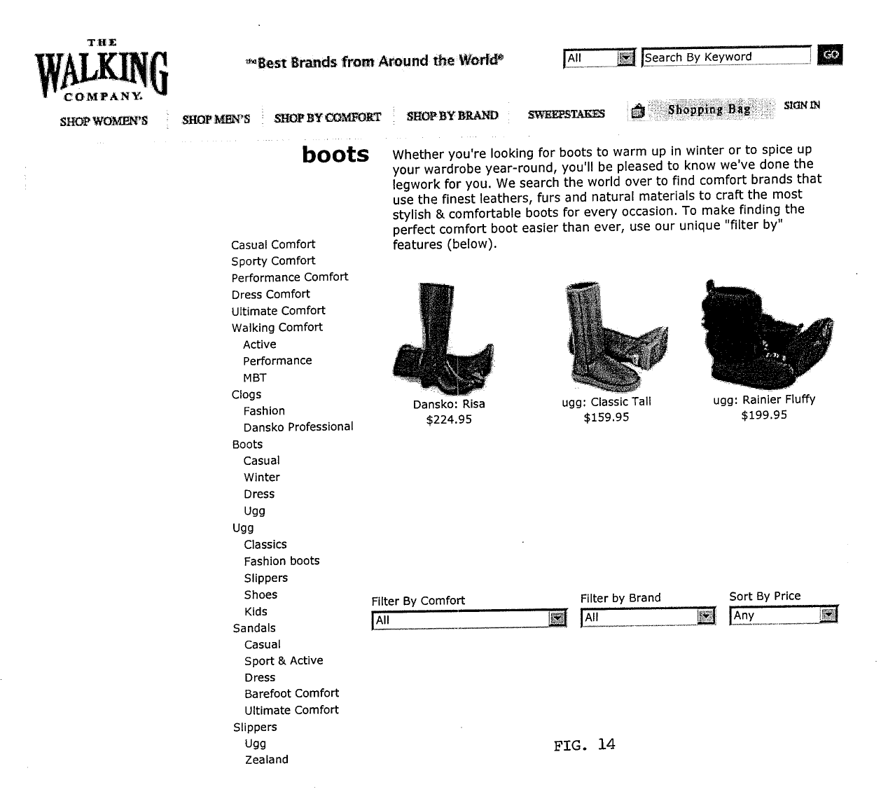

FIG. 14 is a screen shot of a web page displayed after the user selects “see more” in the pop up box having the Dansko Risa (which is only exemplary) shoe shown in FIG. 12. A plurality of boots are displayed preferably having one or more similar characteristics to the shoe initially chosen by the user in FIG. 11.

The foregoing embodiments are merely examples of the present invention. Those skilled in the art may make numerous uses of, and departures from, such embodiments without departing from the spirit and the scope of the present invention. Accordingly, the scope of the present invention is not to be limited to or defined by such embodiments in any way, but rather, is defined solely by the following claims.

What is claimed is:

1. A method for of providing shoe selection services to a person, the method comprising the steps of:
(a) providing a website for the sale of shoes,
(b) providing a list of categories, wherein the list of categories comprises characteristics of shoes,
(c) providing a list of options for each characteristic,
(d) providing a means for selecting an option from the list of options, and
(e) providing a means for evaluating the selected option and displaying shoes based upon the selected option.

2. The method of claim 1, wherein the list of categories comprises characteristics of a shoe wearer.

3. The method of claim 1, wherein characteristics of shoes comprise women's comfort and men's comfort.

4. The method of claim 3, wherein each of women's comfort and men's comfort comprises ultimate, everyday, and fashion.

5. The method of claim 2, wherein characteristics of the shoe wearer comprises arch type, heel height, width, foot condition.

6. A method of providing shoe selection services to a person, the method comprising the steps of:
a. identifying a plurality of selected shoes,
b. categorizing the plurality of identified shoes based upon one or more factors; wherein the one or more factors comprises physical qualities of the shoe,
c. providing an internet website,
e. providing on the website a list of the one or more factors,
f. providing the person with a means for selecting the one or more factors,
g. identifying at least one shoe based upon the selected factor, and
h. displaying the identified shoe on the website.

7. The method of claim 6, wherein the one or more factors comprises physical qualities of a shoe wearer.

8. A method of providing comfort shoe selection services to a person, the method comprising:
b. providing the person with a means for selecting at least one pair of shoes, wherein the at least one pair of shoes is associated with at least one first factor,
wherein the person selects the shoe by selecting the at least one first factor, wherein the at least one first factor comprises at least one physical quality of the shoe.

9. The method of claim 8, wherein the at least one first factor further comprises at least one second factor.

10. The method of claim 9, wherein the at least one first factor comprises women's comfort and men's comfort.

11. The method of claim 10, wherein each of women's comfort and men's comfort further comprises at least one second factor chosen from the group comprising ultimate, everyday, and fashion.

12. The method of claim 8, wherein the at least one first factor comprises foot condition.

13. The method of claim 12, further comprising providing an internet website, wherein the website is operatively coupled to a database and configured to display the shoe information.

14. A system for facilitating a shoe buyer's selection of the appropriate shoes, the system comprising:
(a) a database of selected comfort shoes,
(b) a database of characteristics of the selected comfort shoes,
(c) a database of characteristics of users,
(d) a database comprised of user selection of at least one characteristic chosen from (b) or (c),
(e) a software system for selecting at least one shoe based upon the user's selection in the database of (d), and
(f) means for displaying characteristics of (b), (c), and the selection of (e).

15. The system of claim 14, wherein the characteristics of (b) comprise comfort.

16. The system of claim 15, wherein comfort comprises ultimate, everyday, and fashion.

17. The system of claim 15, wherein the characteristics of (c) comprise arch type, heel height, width, and foot condition.

18. The system of claim 14, wherein the means for displaying is an internet website.
